(19) United States
(12) Patent Application Publication
(10) Pub. No.: US 2005/0018552 A1
(43) Pub. Date: Jan. 27, 2005

(54) Optical integrated device and optical pickup apparatus

(75) Inventor: Isao Tomisawa, Tsurugashima-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/893,413

(22) Filed: Jul. 19, 2004

(30) Foreign Application Priority Data
Jul. 24, 2003 (JP) P2003-200866

(51) Int. Cl. G11B 7/00; G11B 11/00

(52) U.S. Cl. 369/44.12; 369/112.27

(57) ABSTRACT

An optical integrated device includes an optical coupling part for introducing at least a part of reflected light from an optical recording medium such as an optical disk into an optical waveguide, and light receiving portions for receiving the guided light having propagated through the optical waveguide and generating detection signals. The optical coupling part is constituted by plural optical coupling portions, and the plural optical coupling portions are optimized for plural positions different from each other of concentration positions of the light beam applied to the optical recording medium, respectively. Thereby, the capture range of a focus error signal can be adjusted to fall within a desired range.

### BACKGROUND OF THE INVENTION

1. Field of the Invention

The present invention relates to an optical pickup apparatus for optically reproducing information recorded in an optical recording medium such as an CD (Compact Disc), a DVD (Digital Versatile Disc), and an LD (Laser Disc), or for optically recording information in the optical recording medium, and an optical integrated device incorporated in the optical pickup apparatus and so on.

2. Description of the Related Art

In an optical pickup apparatus, information recorded in an optical recording medium is reproduced by applying a laser beam onto an optical recording medium, and detecting the reflected light (return light) from the optical recording medium. Further, as a photo-detection element for detecting the return light from the optical recording medium, an optical integrated device in which optical functions of the optical pickup are integrated is adopted in light of miniaturization, thickness-reduction, and cost-reduction of the optical pickup apparatus.

By the way, the laser beam is concentrated onto the information recording surface of the optical recording medium by an objective lens, however, the concentration position of the laser beam departs from the information recording surface due to displacement such as eccentricity or runout of the optical recording medium. Accordingly, focus servo for driving the objective lens to compensate for the displacement in real time is performed, using a focus error signal obtained by detecting the displacement of the recording medium. The above described optical integrated device has an optical function of focus error signal detection.

As the optical integrated device, for example, an optical integrated device disclosed in Japanese Patent Application Laid-Open No. 2000-215504, FIGS. 1 and 2, paragraphs [0028], [0035], [0036], and [0047]) is publicly known. The disclosure of the corresponding U.S. Pat. No. 6,639,887 is hereby incorporated by reference in its entirety. In the optical integrated device, an optical coupling device for generating guided light and transmitted light from incident light from an optical recording medium and two kinds of photodetectors for receiving the transmitted light and the guided light, respectively, are formed on a semiconductor substrate. Further, the optical coupling device includes a grating for diffracting a part of the incident light and introducing it as guided light into an optical waveguide. Furthermore, the photodetector for receiving the guided light generates a focus error signal according to the beam size method (Foucault method), and the photodetector for receiving the transmitted light generates a tracking error signal or RF signal.

As described below, the waveform of the focus error signal emerges in an S-shaped curve or an inversed S-shaped curve only in the vicinity of a focusing point, and the range (capture range) in which the S-shaped waveform or the inversed S-shaped waveform (focusing waveform) can be used is limited. Since the grating of the optical integrated device is optimally designed for the incident luminous flux at the time of focusing, when the concentration position of the laser beam is in the focusing position, the amount of light of the guided light detected by the photodetector is large, however, if the concentrated spot of the laser beam departs slightly from the recording surface of the optical recording medium, the ratio of the guided light introduced into the optical waveguide is largely reduced. In other words, optical coupling efficiency is largely deteriorated. On this account, sometimes the capture range of the focus error signal easily becomes narrow, and focus servo control becomes unstable.

In light of the above circumferences, an object of the invention is to provide an optical integrated device and an optical pickup apparatus capable of stabilizing focus servo control.

### SUMMARY OF THE INVENTION

The invention according to claim 1 relates to an optical integrated device for detecting a reflected light beam from an optical recording medium when an incident light beam concentrated by an optical system is applied onto the optical recording medium, comprising:

an optical waveguide for propagating light;

plural optical coupling portions for guiding at least a part of the reflected light beam into the optical waveguide; and

a light receiving element for receiving guided light after propagating through the optical waveguide, and generating a detection signal in response thereto,

wherein the plural optical coupling portions are optimized for plural positions different from each other of concentration positions of the light beam applied onto the optical recording medium, respectively.

### BRIEF DESCRIPTION OF THE DRAWINGS

FIG. 1 schematically shows a partial constitution of an optical pickup apparatus as an embodiment according to the invention.

FIG. 2 is a plan view schematically showing the constitution of the optical integrated device of the first embodiment.

FIG. 3 is a sectional view taken along A1-A2 line of the optical integrated device shown in FIG. 2.

FIG. 4 is an explanatory view of the optical coupling principle.

FIG. 5 is a graph exemplifying a level distribution FE (x) of the FE signal.

FIG. 6 is a plan view schematically showing the constitution of the optical integrated device of the first embodiment.

FIG. 7 is a plan view schematically showing the constitution of the optical integrated device of the first embodiment.

FIG. 8 is a plan view exemplifying the structure of the grating.

FIG. 9 is a plan view exemplifying the structure of the grating.

FIGS. 10A and 10B are graphs schematically showing received light amount distributions S₁(x) and S₂(x).

FIG. 11 is a graph schematically exemplifying the total received light amount distribution S(x) and the level distribution FE (x) of the FE signal.

FIG. 12 is a graph schematically exemplifying the total received light amount distribution S(x) and the level distribution FE (x) of the FE signal.

FIG. 13 is a plan view schematically showing the constitution of the optical integrated device of the second embodiment.

FIG. 14 is a sectional view taken along A3-A4 line of the optical integrated device shown in FIG. 13.

FIG. 15 is a plan view exemplifying the structure of the grating consisting of two kinds of optical coupling portions.

FIG. 16 shows a concentration point of the guided light formed by the grating.

FIG. 17 shows a concentration point of the guided light formed by the grating.

FIG. 18 is a graph schematically exemplifying the total received light amount distribution S(x) and the level distribution FE (x) of the FE signal.

FIGS. 19A and 19B are graphs schematically showing received light amount distributions S₁(x) and S₂(x).

### DESCRIPTION OF THE PREFERRED EMBODIMENTS

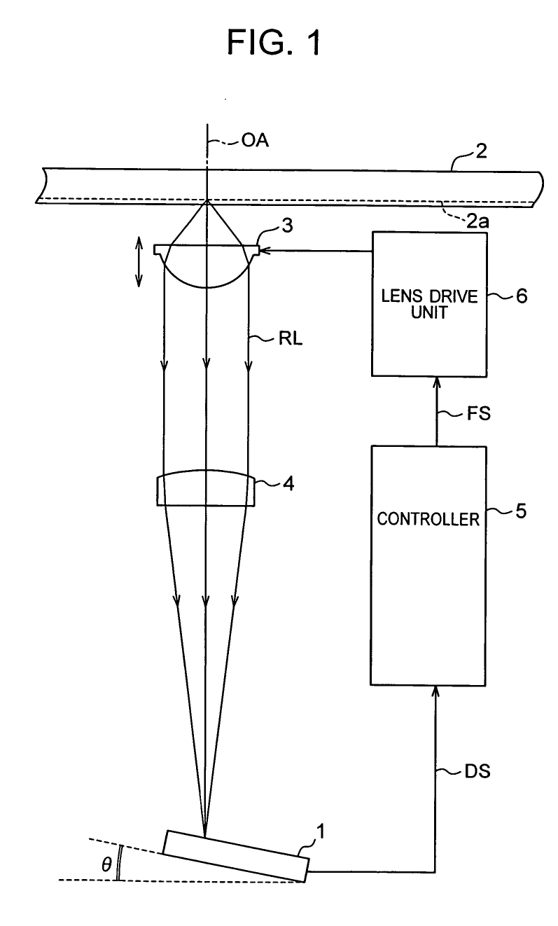

FIG. 1 schematically shows a partial constitution of an optical pickup apparatus as an embodiment according to the invention. The optical pickup apparatus includes an optical integrated device 1, an objective lens (optical system) 3, a collimator lens 4, a controller 5, and a lens drive unit 6. The optical integrated device 1, the objective lens 3, and the collimator lens 4 are arranged along the optical axis OA of the objective lens 3. Micro pits (signal grooves) representing information are grooved on an information recording surface 2a of a disc shaped optical disk (optical recording medium) 2, and the optical disk 2 is rotationally driven at the time of recording and reproduction.

A coherent light beam output from a laser diode light source (not shown) for recording and reproduction is collimated by being refracted by the collimator lens 4, and then, enters the objective lens 3. The objective lens 3 has a function of concentrating the entering light beam onto the information recording surface 2a, and at the time of focusing, the position of the concentrated spot of the light beam (hereinafter, referred to as “concentration position”) matches, and fits with the recording track of the information recording surface 2a. By the way, as the objective lens 3, not only the optical lens having a fixed focus but also a variable focus lens that can vary the focal point according to the control signal may be used.

The reflected light beam RL from the optical disk 2 is transmitted through the objective lens 3 and the collimator lens 4 sequentially, and enters the optical integrated device 1. The optical integrated device 1 tilts to an angle θ relative to a plane perpendicular to the optical axis OA, and generates plural detection signals DS by receiving entering reflected light beam RL and photoelectrically converting it, and outputs them to the controller 5 (servo circuit). The controller 5 generates servo signals such as a focus error signal (hereinafter, referred to as“FE signal”) and a tracking error signal (hereinafter, referred to as “TE signal”), and an RF signal, based on the detection signals DS. Further, the lens drive unit 6 moves the position of the objective lens 3 upward and downward along the focusing direction (direction of the optical axis OA), using the FE signal FS of the servo signals as a drive signal.

An embodiment of the optical integrated device 1 mounted on the optical pickup apparatus having the above-described constitution will be described as below.

[First Embodiment]

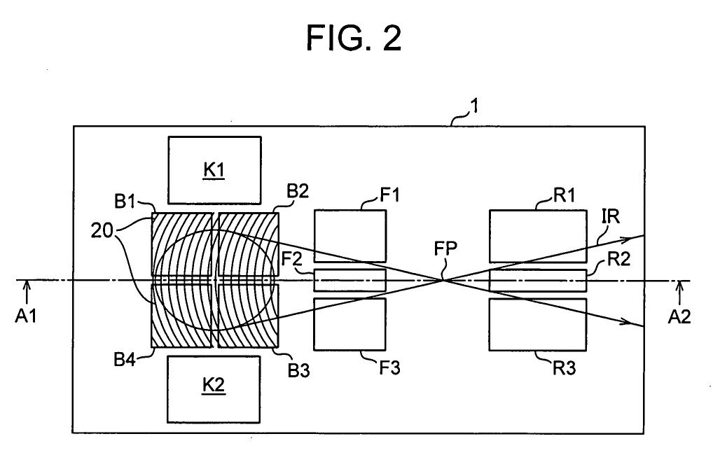

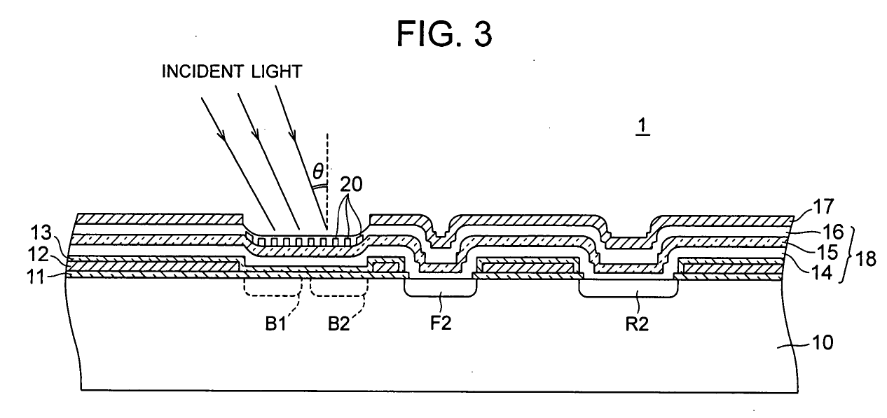

FIG. 2 is a plan view schematically showing the constitution of the optical integrated device 1 of the first embodiment, and FIG. 3 is a sectional view taken along A1-A2 line of the optical integrated device 1. As shown in FIG. 2, a grating (optical coupling element) 20 having lattice grooves of a predetermined period is formed in a curved shape on the light entrance surface of the optical integrated device 1. Further, immediately below the grating 20 formed area, four light receiving portions B1, B2, B3, and B4 for RF signal are formed on a silicon substrate 10. Furthermore, on the same silicon substrate 10, two light receiving portions K1 and K2 for TE signal, and six light receiving portions F1, F2, F3, R1, R2, and R3 for FE signal are formed. These light receiving portions K1, K2, B1 to B4, F1 to F3, and R1 to R3 may be either photodiodes or OEICs (photodiodes having amplifiers built-in).

As shown in FIG. 3, on the silicon substrate 10 having the light receiving portions B1 to R3 thereon, a thermal oxide film 11, an aluminum light blocking film 12, and a protective film 13 are laminated in this order, using the photolithography technique and the etching technique. Further, on these three layers 11 to 13, an optical waveguide 18 consisting of a lower cladding layer 14 having a high reflective index, a optical waveguide layer 15 having a low reflective index, and an upper cladding layer 16 having a high reflective index is formed. The lower cladding layer 14 is formed by applying SOG (Spin On Glass) using the spin coating method, and the optical waveguide layer 15 is formed on this lower cladding layer 14 by depositing a dielectric material such as silicon oxide (SiO₂) thereon using the sputtering method.

Furthermore, on the optical waveguide layer 15, the grating 20 having a large number of lattice grooves of a predetermined period formed in a curved shape is provided, using the photo lithography technique and the etching technique. The upper cladding layer 16 is formed on the optical waveguide layer 15 by applying SOG using the spin coating method. Further, an aluminum light blocking film 17 is formed on the upper cladding layer 16 except for the light entrance surface.

In addition, as shown in FIG. 3, in the areas above the light receiving portions F1 to F3 and R1 to R3 for FE signal, the lower cladding layer 14 is formed so as to be thinner compared to that in other areas. That is, since the loss of the guided light IR become larger if the lower cladding layer 14 is thin in areas other than the areas above the light receiving portions F1 to F3 and R1 to R3, in order to avoid this, the lower cladding layer 14 is formed so as to have a gradual inclination in the vicinity of the peripheral portions of the light receiving portions F1 to F3 and R1 to R3, and the lower cladding layer 14 above the light receiving portions F1 to F3 and R1 to R3 is formed thinner.

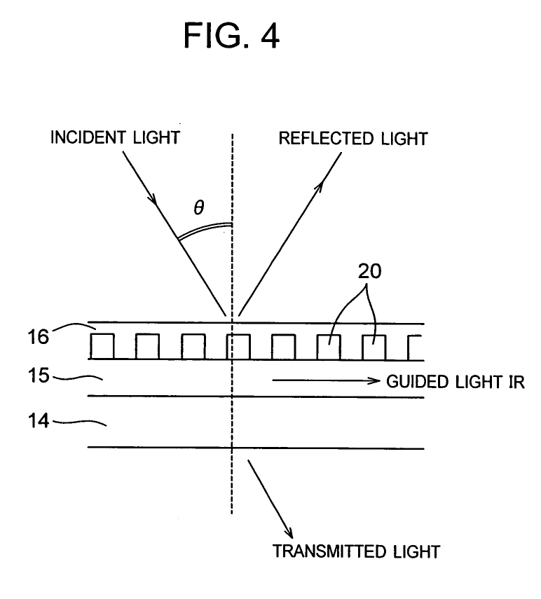

As shown in FIG. 4, the light entered at angle θ is separated into guided light IR diffracted by the grating 20 and transmitted light transmitted through the optical waveguide layer 15 and the lower cladding layer 14 without being diffracted. The guided light IR diffracted by the grating 20 propagates within the optical waveguide layer 15 to the light receiving portions F1 to F3 and R1 to R3. Further, as shown in FIG. 2, the guided light IR is concentrated onto a point FP within the optical waveguide layer 15 by the grating 20 having curved lattice grooves. Note that, in the example shown in FIG. 4, the guided light IR is concentrated onto the one point FP for convenience of description, however, the grating 20 is constituted by plural optical coupling portions having grating patterns different from each other, and by the constitution, the guided light IR can be concentrated onto plural points along the optical axis according to the respective grating patterns.

Next, a generating method of the servo signal and the RF signal will be described. Here, it is assumed that a detection signal of the light receiving portion X (the sign X is one of B1 to R3) is represented by S(X). The RF signal is given by the summation of the detection signals generated by the light receiving portions B1, B2, B3, and B4. That is, expressed by an mathematical expression, RF signal=S(B1)+S(B2)+S(B3)+S(B4).

The light receiving portions F1 to F3 and R1 to R3 on front and rear sides are light receiving elements formed for FE signal. A first group of light receiving portions are constituted by the light receiving portions F1 and F3, on both ends of the front side light receiving portions F1 to F3, and the central light receiving portion R2 of the rear side light receiving portions R1 to R3, and a second group of light receiving portions are constituted by the central light receiving portion F2 of the front side light receiving portions F1 to F3, and the light receiving portions R1 and R3 on both ends of the rear side light receiving portions R1 to R3. The FE signal is given by the difference between the detection signals generated in the first group light receiving portions F1, R2, and F3 and the second group light receiving portions R1, F2, and R3. Expressed by an mathematical expression, FE signal=S(F1)+S(R2)+S(F3)−(S(R1)+S(F2)+S(R3)).

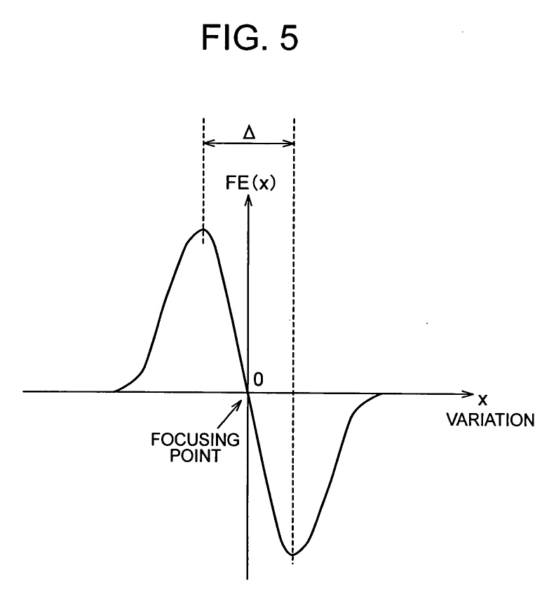

FIG. 5 is a graph exemplifying a level distribution FE (x) of the FE signal. The horizontal axis of the graph corresponds to the distance x between the information recording surface 2a of the optical disk 2 and the concentration position of the laser beam, i.e., defocusing amount x. In other words, this distance x means a variation along the focusing direction of the information recording surface 2a relative to the concentration position of the laser beam. The intersection of the vertical axis and the horizontal axis of the graph indicates a focusing point where the level of the FE signal becomes zero and the focal point of the optical system 3 matches the information recording surface 2a. Further, on the focusing point, as shown in FIG. 2, the guided light IR is converged on the point FP substantially in the intermediate position between the front side light receiving portions F1 to F3 and the rear side light receiving portions R1 to R3, and the amount of received light in the front side light receiving portions F1 to F3 and the amount of received light in the rear side light receiving portions R1 to R3 become nearly the same, and the equation S(F)+S(R2)+S(F3)=S(R1)+S(F2)+S(R3) is held.

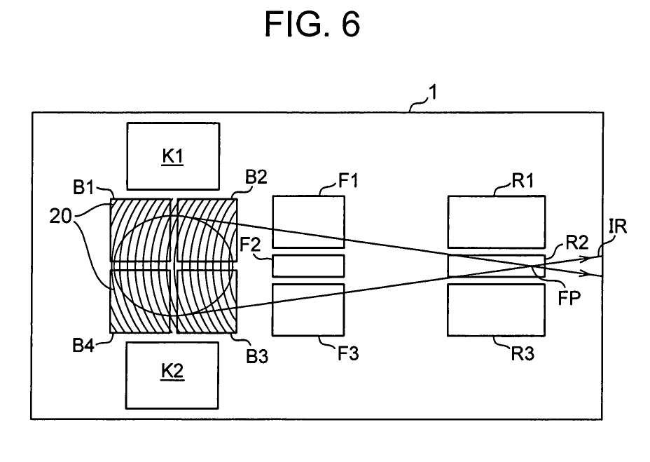

From the focusing condition shown in FIG. 2 to the defocusing condition in which the information recording surface 2a of the optical disk 2 approaches the objective lens 3, the concentration point FP of the guided light IR moves toward the rear side light receiving positions R1 to R3 as shown in FIG. 6, and the inequality S(F1)+S(R2)+S(F3)>S(R1)+S(F2)+S(R3) is held.

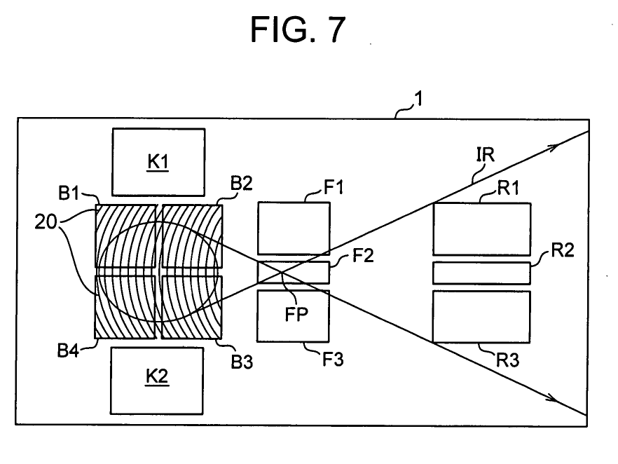

On the other hand, from the focusing condition shown in FIG. 2 to the defocusing condition in which the information recording surface 2a of the optical disk 2 is away from the objective lens 3, the concentration point FP of the guided light IR moves toward the front side light receiving portions F1 to F3 as shown in FIG. 7, and the inequality S(F1)+S(R2)+S(F3)<S(R1)+S(F2)+S(R3) is held.

Thus, the level distribution FE (x) of the FE signal forms an inversed S shaped waveform with respect to the distance x as shown in FIG. 5. The focus servo control is executed so that the distance x may become zero mainly utilizing the waveform between the maximum peak and the minimum peak of the level distribution FE (x). As described above, if the peak to peak distance A (capture range) of the level distribution FE (x) is too short, the focus servo control easily becomes unstable. In the conventional optical integrated device, since characteristics of the grating are optimized for the time of focusing, the capture range A becomes narrow, causing the instability of the focus servo control.

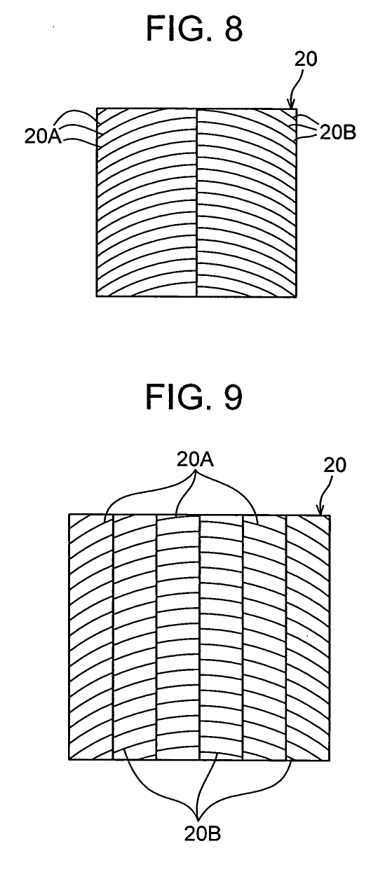

The grating 20 is constituted by plural optical coupling portions having grating patterns (optical coupling characteristics) different from each other, and these plural optical coupling portions are optimized respectively for plural positions different from each other of the concentration positions of the light beam, which vary according to the position of the objective lens 3. Specifically, each optical coupling portion is optimized for the concentration position when the light beam becomes in the defocusing condition on the information recording surface 2a of the optical disk 2. In the embodiment, the grating 20 is constituted by two kinds of optical coupling portions. FIGS. 8 and 9 are plan views exemplifying the structure of the grating 20. The grating 20 shown in FIG. 8 is divided into two areas, and optical coupling portions 20A and 20B having different grating patterns are formed in the two areas, respectively. Further, the grating 20 shown in FIG. 9 is divided into eight areas, and constituted by an optical coupling portion 20A consisting of four areas having a first grating pattern, and an optical coupling portion 20B consisting of four areas having a second grating pattern. Here, the number of area division of the grating 20 shown in FIG. 9 is eight, however, the number of area division is preferably increased according to the situation. Further, the lattice grooves of the optical coupling portions 20A and 20B are formed in curved shapes, however, the lattice grooves of the respective divided areas may be linearly formed instead.

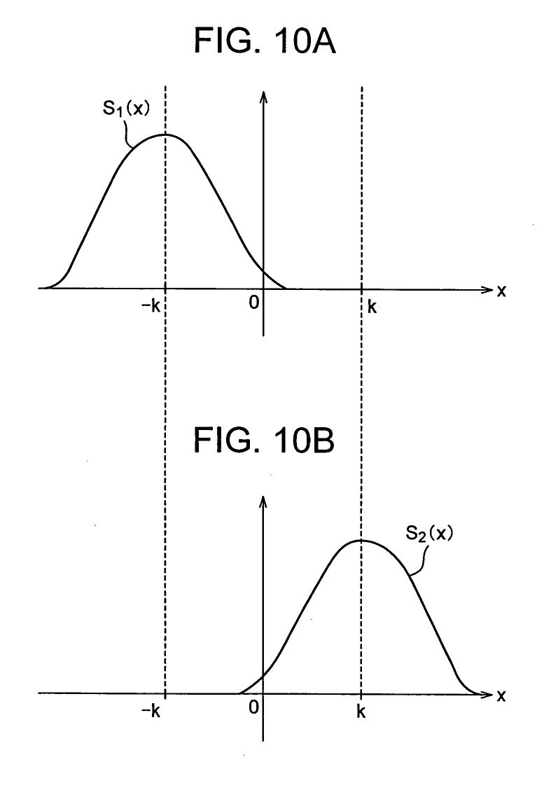

The amount of light of the guided light introduced by the grating 20 is proportional to the level of the sum signal (hereinafter, referred to as “amount of received light”) obtained by adding the detection signals generated in the front and rear side light receiving portions F1 to F3 and R1 to R3 (FIG. 2). FIGS. 10A and 10B are graphs showing amounts of received lights S₁(x) and S₂(x) of the guided light IR diffracted by the optical coupling portions 20A and 20B. The horizontal axis of the graph corresponds to the distance x between the information recording surface 2a of the optical disk 2 and the concentration position of the laser beam, i.e., defocusing amount x. The intersection of the vertical axis and the horizontal axis of the graph indicates the focusing point. Further, one amount of received light S₁(x) represents an amount of the guided light IR diffracted only by the first optical coupling portion 20A, and the other amount of received light S₂(x) represents an amount of the guided light IR diffracted only by the second optical coupling portion 20B, respectively.

As shown in FIG. 10A, the amount of received light S₁(x) obtained by the first optical coupling portion 20A has a distribution that forms the maximum peak in the defocusing position (x=−k) where the concentration position of the light beam departs from the information recording surface 2a in the direction opposite to the objective lens 3, and attenuates as the concentration position goes away from the defocusing position. Further, as shown in FIG. 10B, the amount of received light S₂(x) obtained by the second optical coupling portion 20B has a distribution that forms the maximum peak in the defocusing position (x=k) where the concentration position of the light beam departs from the information recording surface 2a in the direction toward the objective lens 3, and attenuates as the concentration position goes away from the defocusing position. Thus, the first and second optical coupling portions 20A and 20B are optimally designed so that the amount of light of the guided light IR when the light beam entering the information recording surface 2a is in the defocusing condition on the information recording surface 2a becomes larger compared to that in the focusing condition, respectively.

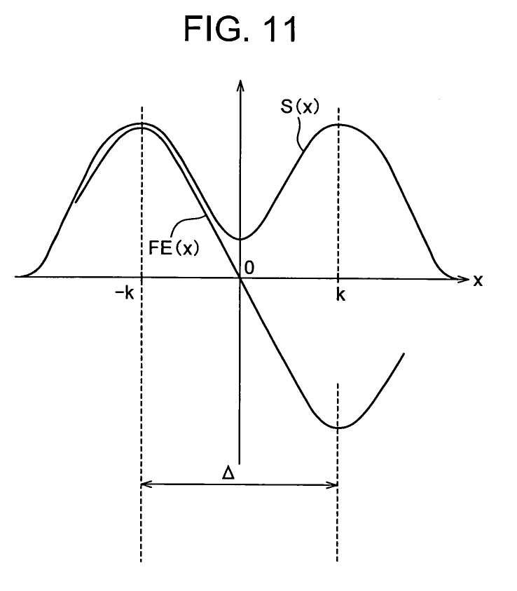

By the grating structure obtained by combining the above-mentioned first and second optical coupling portions 20A and 20B, the total amount of received light S₁(x)+S₂(x) can form the light amount distribution S (x) having two maximum peaks with respect to the variation x of the optical disk 2, as shown in FIG. 11. In the light amount distribution S(x), the two maximum peaks are formed in symmetrical positions (x=+k, −k) relative to the focusing point (x=0).

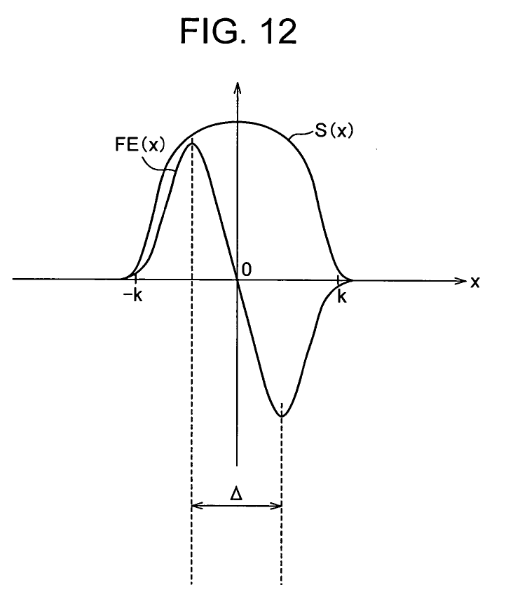

On the other hand, since the conventional grating structure has one kind of grating pattern optimized for the focusing position, the maximum peak of the total received light amount distribution S(x) is formed only at the focusing point as shown in FIG. 12, and the capture range A of the level distribution FE (x) of the FE signal easily becomes narrow. By contrast, in the grating structure of the embodiment, it is seen that the capture range as the peak to peak distance A of the level distribution FE (x) can be enlarged according to the positions of the two maximum peaks of the total received light amount distribution S(x) as shown in FIG. 11.

As described above, since the grating 20 of the optical integrated device 1 of the first embodiment has plural optical coupling portions 20A and 20B optimized for the incident luminous flux in the defocusing condition, the capture range A of the FE signal can be adjusted to fall within a desired range where focus servo control can be stabilized. Therefore, the characteristic of following for the focus servo to the displacement of the optical information recording medium can be improved.

[Second Embodiment]

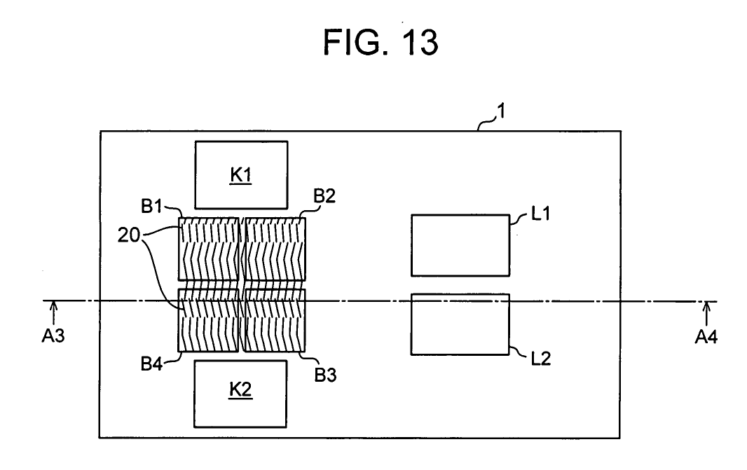

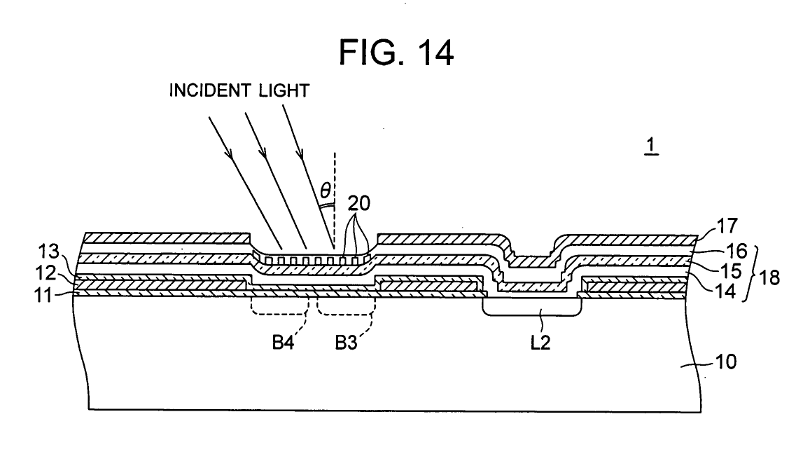

As below, the second embodiment according to the invention will be described. FIG. 13 is a plan view schematically showing the constitution of the optical integrated device 1 of the second embodiment, and FIG. 14 is a sectional view of the optical integrated device 1 taken along A3-A4 line. On the light entrance surface of the optical integrated device 1, the grating 20 (optical coupling element) having lattice grooves of a predetermined period is formed. Further, immediately below the grating 20, four light receiving portions B1 to B4 for RF signal are formed on the silicon substrate 10, and furthermore, on the silicon substrate 10, two light receiving portions K1 and K2 for TE signal and two light receiving portions L1 and L2 for FE signal are formed.

On the silicon substrate 10 having the light receiving portions for RF signal, TE signal, and FE signal thereon, the thermal oxide film 11, the aluminum light blocking film 12, the protective film 13, the lower cladding layer 14, the optical waveguide layer 15, the upper cladding layer 16, and the light blocking film 17 are formed by the same manufacturing process as that of the optical integrated device 1 (FIG. 2) of the first embodiment. The optical waveguide 18 is constituted by the lower cladding layer 14 having a high refraction index, the optical waveguide layer 15 having a low refraction index and the upper cladding layer 16 having a high refraction index.

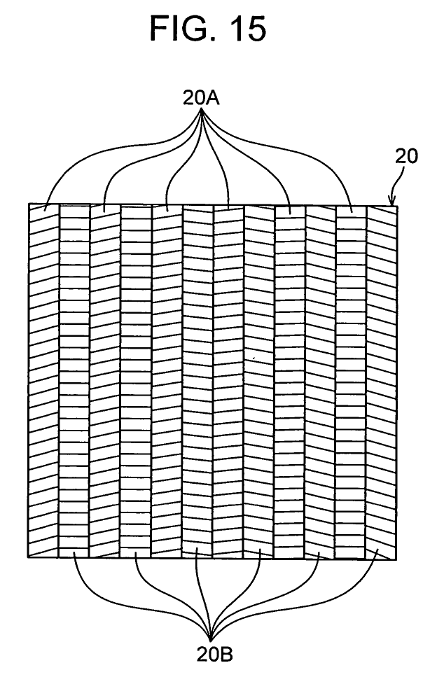

The grating 20 is constituted by plural optical coupling portions having grating patterns (optical coupling characteristics) different from each other, and these plural optical coupling portions are optimized respectively for plural positions different from each other of the concentration positions of the light beam, which vary according to the position of the objective lens 3. Specifically, each optical coupling portion is optimized for the concentration position when the light beam is in the defocusing condition on the information recording surface 2a of the optical disk 2. FIG. 15 is a plan view exemplifying the structure of the grating 20 consisting of two kinds of optical coupling portions 20A and 20B. The grating 20 is divided into 12 areas, and has the optical coupling portion 20A consisting of six areas having the first grating pattern and the optical coupling portion 20B consisting of six areas having the second grating pattern. The respective grating patterns of the optical coupling portions 20A and 20B provide optical capability of diffracting the incident light in the defocusing condition, and concentrating the guided light IR onto one point.

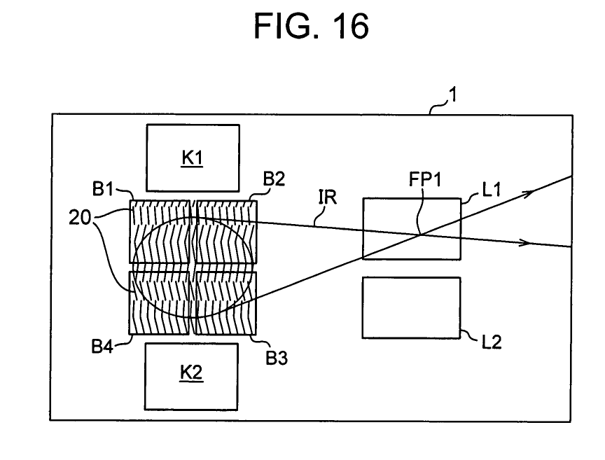

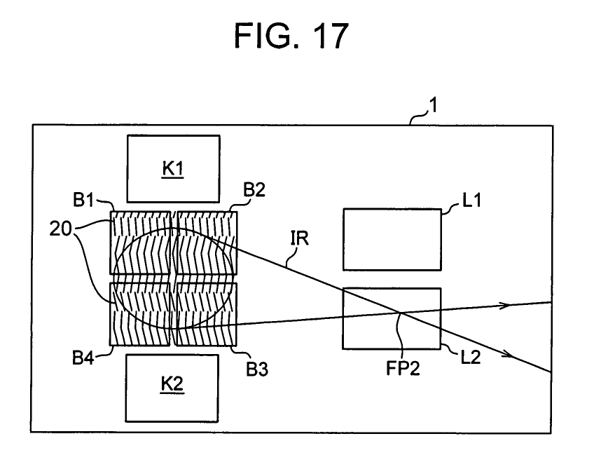

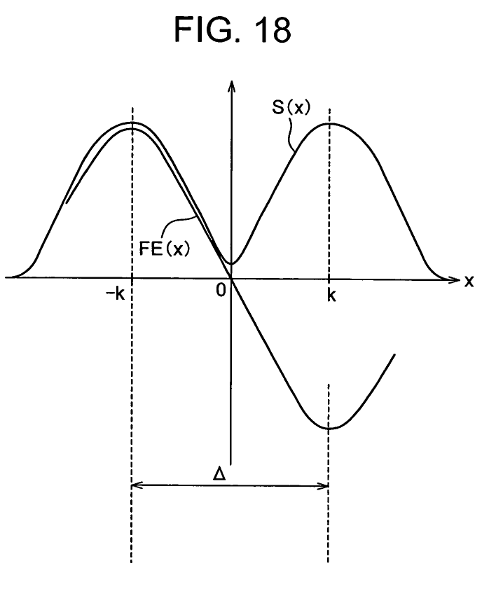

FIGS. 16 and 17 show concentration points FP1 and FP2 of the guided light IR formed by the grating 20, and FIG. 18 is a graph schematically showing the total received light amount distribution S(x) in the light receiving portions L1 and L2. The horizontal axis of the graph in FIG. 18 corresponds to the distance x between the information recording surface 2a and the concentration position of the laser beam, i.e., defocusing amount x. Further, the total received light amount distribution S(x) represents the level distribution of the sum signal obtained by adding the detection signals generated in the light receiving portions L1 and L2.

In the focusing condition (x=0) in which the concentration position of the light beam entering the optical disk 2 matches the information recording surface 2a, the grating 20 hardly diffracts the incident light, and the total amount of received light S (x=0) at the time of focusing has a very little value, as shown in FIG. 18.

Further, in the defocusing condition in which the position of the information recording surface 2a departs from the focusing position by a predetermined distance (x=−k) in the direction approaching the objective lens 3, the optical coupling portion 20A optimized for the defocusing condition diffracts the incident light, and concentrate the guided light IR onto the point FP1 shown in FIG. 16. Since the light receiving portion L1 is formed in the vicinity below the concentration point FP1, the total amount of received light S (x=−k) forms the maximum peak, as shown in FIG. 18.

Furthermore, in the defocusing condition in which the position of the information recording surface 2a departs from the focusing position by a predetermined distance (x=+k) in the direction away from the objective lens 3, the optical coupling portion 20B optimized for the defocusing condition diffracts the incident light, and concentrate the guided light IR onto the point FP2 shown in FIG. 17. Since the light receiving portion L2 is formed in the vicinity below the concentration point FP2, the total amount of received light S (x=k) forms the maximum peak as shown in FIG. 18.

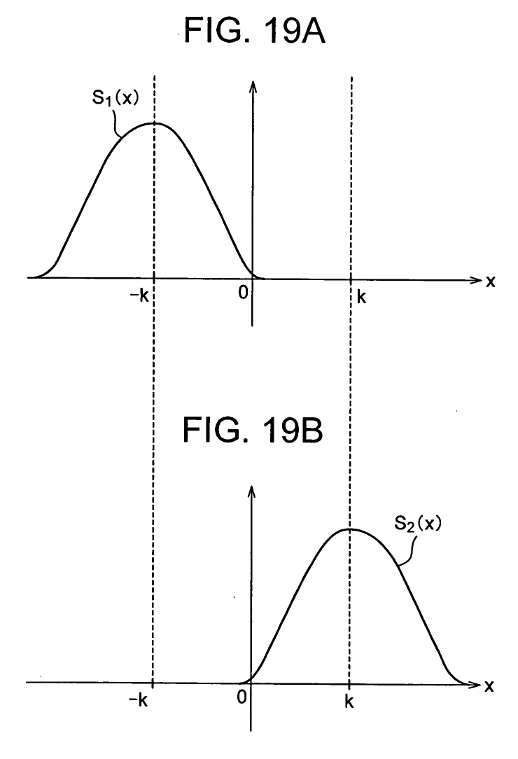

Therefore, as shown in FIG. 18, the total received light amount distribution S (x) having two maximum peaks at the two points corresponding to the defocusing conditions is formed. FIG. 19A shows the level distribution S₁(x) of the detection signal generated by one light receiving portion L1, and FIG. 19B shows the level distribution S₂(x) of the detection signal generated by the other light receiving portion L2. The total received light amount distribution S (x) is superposition of these level distributions S₁(x) and S₂(x). As shown in FIG. 19A, the distribution S₁(x) obtained by the first optical coupling portion 20A has a distribution that forms the maximum peak in the defocusing position (x=−k) where the concentration position of the light beam departs from the information recording surface 2a in the direction opposite to the objective lens 3, and attenuates as the concentration position goes away from the defocusing position. Further, as shown in FIG. 19B, the distribution S₂(x) obtained by the second optical coupling portion 20B has a distribution that forms the maximum peak in the defocusing position (x=k) where the concentration position of the light beam departs from the information recording surface 2a in the direction toward the objective lens 3, and attenuates as the concentration position goes away from the defocusing position. Thus, the first and second optical coupling portions 20A and 20B are optimally designed so that the amount of light of the guided light IR in the defocusing condition becomes larger compared to that in the focusing condition, respectively.

Since the FE signal is given by the difference between the detection signal generated in the first light receiving portion L1 and the detection signal generated in the second light receiving portion L2, assuming that the detection signal of the light receiving portion X (X is either L1 or L2) is expressed by the S(X), the FE signal can be expressed by FE signal=S(L1)−S(L2). Accordingly, the level distribution FE(x) of the FE signal gives the inversed S shaped focusing waveform, as shown in FIG. 18. From FIG. 18, it is seen that the capture range Δ as the peak to peak distance of the FE signal can be adjusted according to the position of the maximum peak of the total received light amount distribution S(x).

As described above, according to the optical integrated device 1 of the second embodiment, since the grating 20 has plural optical coupling portions 20A and 20B optimized for the incident luminous flux in the defocusing condition, the capture range Δ of the FE signal can be adjusted to fall within a desired range where focus servo control can be stabilized. Therefore, the characteristic of following for the focus servo to the displacement of the optical information recording medium can be improved.

Further, since the amount of light of the guided light IR at the time of focusing can be made small, as shown in FIG. 19, even if the light spot of the reflected light beam RL entering the optical integrated device 1 departs slightly from the optical axis, or noise is mixed in the detection signal, the distortion of the focusing waveform can be suppressed very low, and the characteristic of following for the focus servo can be improved.

As above, the first and second embodiments have been described. In the above first and second embodiments, the grating 20 having two kinds of grating patterns has been described, however, in the invention, a grating having not only two kinds but also N kinds (N is an integral number equal to or more than 3) of grating patterns can be adopted.

Further, in the above first and second embodiments, it is preferred that the two maximum peaks of the total received light amount distribution S(x) are formed in the symmetrical positions relative to the focusing point in light of adjustment of the capture range A within the desired range in the vicinity of the focusing point, however, the two maximum peaks may depart slightly from the symmetrical positions.

It should be understood that various alternatives to the embodiments of the invention described herein may be employed in practicing the invention. Thus, it is intended that the following claims define the scope of the invention and that methods and structures within the scope of these claims and their equivalents be covered thereby.

The entire disclosure of Japanese Patent Application No. 2003-200866 filed on Jul. 24, 2003 including the specification, claims, drawings and abstract is incorporated herein by reference in its entirety.

1. An optical integrated device for detecting a reflected light beam from an optical recording medium when an incident light beam concentrated by an optical system is applied onto the optical recording medium, comprising:
an optical waveguide for propagating light;
plural optical coupling portions for guiding at least a part of the reflected light beam into the optical waveguide; and
a light receiving element for receiving guided light after propagating through the optical waveguide, and generating a detection signal in response thereto,
wherein the plural optical coupling portions are optimized for plural positions different from each other of concentration positions of the light beam applied onto the optical recording medium, respectively.

2. An optical integrated device according to claim 1, wherein the plural optical coupling portions are optimized so as to cause an amount of received light by the receiving element to form a distribution having plural maximum peaks with respect to a distance between the concentration position of the light beam and an information recording surface.

3. An optical integrated device according to claim 2, wherein the plural maximum peaks are formed symmetrically relative to a point corresponding to a focusing condition in the distribution.

4. An optical integrated device according to claim 1, wherein the plural optical coupling portions are optimized so as to cause an amount of the guided light when the incident light beam is in a defocusing condition on an information recording surface of the optical recording medium to be larger compared to that in a focusing condition.

5. An optical integrated device according to claim 4, wherein the plural optical coupling portions include a first optical coupling portion and a second optical coupling portion,
the first optical coupling portion is optimized so as to cause the amount of the guided light to form the maximum peak when the concentration position of the light beam is in a first predetermined position departing from the information recording surface in a direction toward the optical system, and cause the amount of the guided light to attenuate as the concentration position goes away from the first predetermined position, and
the second optical coupling portion is optimized so as to cause the amount of the guided light to form the maximum peak when the concentration position of the light beam is in a second predetermined position departing from the information recording surface in a direction opposite to the optical system, and cause the amount of the guided light to attenuate as the concentration position goes away from the second predetermined position.

6. An optical integrated device according to claim 1, wherein, when the incident light beam is in a defocusing condition on the information recording surface of the optical recording medium, the plural optical coupling portions have optical capability of concentrating the guided light onto plural concentration points corresponding to a plurality of the defocusing condition, respectively.

7. An optical integrated device according to claim 6, wherein the light receiving element includes plural light receiving portions formed in the vicinity of the plural concentration points, respectively.

8. An optical integrated device according to claim 1, wherein the light receiving element includes a first light receiving portion and a second light receiving portion, and a focus error signal is generated by a difference between a detection signal generated in the first light receiving portion and a detection signal generated in the second light receiving portion.

9. An optical integrated device according to claim 1, wherein the plural optical coupling portions have plural optical coupling characteristics different from each other.

10. An optical integrated device according to claim 9, wherein the plural optical coupling portions include plural gratings having grating patterns different from each other.

11. An optical integrated device according to claim 1, the device including an integrated circuit having a single semiconductor substrate, the optical waveguide formed on the semiconductor substrate, the plural optical coupling portions, and the light receiving element.

12. An optical pickup apparatus for applying a light beam onto an optical recording medium, and detecting a reflected light beam from the optical recording medium, comprising:
a light source for outputting a light beam to be applied onto the optical recording medium;
an optical system for concentrating the light beam onto the optical recording medium; and
the optical integrated device according to claim 1.
